(19) United States
(12) Patent Application Publication
(10) Pub. No.: US 2006/0137686 A1
(43) Pub. Date: Jun. 29, 2006

(54) Normobaric infection control

(76) Inventor: George P. Macris, Dededo, GU (US)

Correspondence Address: ROBERT R. THORNTON, 3264 MEADOWLARK LANE, CARLSBAD, CA, 92008-2024, US

(21) Appl. No.: 11/311,385

(22) Filed: Dec. 19, 2005

Related U.S. Application Data
(60) Provisional application No. 60/640,330, filed on Dec. 29, 2004.

(51) Int. Cl. A62B 17/04; A62B 18/00

(52) U.S. Cl. 128/201.22; 128/201.23

(57) ABSTRACT

Normobaric infection control apparatus and method utilizing a portable, inflatable oxygen treatment type hood having an inlet port to which an inhalation gas conduit is connected and an outlet port to which an exhaled gas conduit is connected, and in which, in a first structural embodiment and method, provides normobaric infection control of a user's exhalations by means of exhaled gas filter means disposed in the exhaled gas conduit, and which, in a second structural embodiment and method, provides normobaric infection control of the inhalations of a user by means of inhalation gas filter means disposed in the inhalation gas conduit.

### CROSS-REFERENCE TO RELATED APPLICATION

This application claims the benefit of U.S. Provisional Application No. 60/640,330, filed Dec. 29, 2004.

### FIELD OF THE INVENTION

The present invention relates to the use of oxygen hood assemblies generally, and more specifically to apparatus and methods for using this general type of hood to provide for normobaric infection control.

### BACKGROUND OF THE INVENTION

Various prior art devices are known for use by medical personnel during surgery in protecting the user from infection. Examples of such devices are described in U.S. Pat. No. 4,019,508, issued April 26, to Estephan Der Esterphanian, et al., and in U.S. Pat. No. 5,042,474, issued Aug. 27, 1991 to Ian M. Williamson. Other prior art devices are known for use by medical personnel during surgery in protecting the patient from infection by the user. An example of such a device is described in U.S. Pat. No. 3,955,570, issued May 11, 1976 to Charles G. Hutter. However, such prior art devices are bulky and not readily adapted for use in isolating a patient from the patient's surrounding environment during and after the surgical procedure, so as to protect caregiving medical personnel from contracting an infectious patient's infection, or to protect the patient from contracting an infection from the patient's environmental surroundings.

A prior art device, namely a mask, is described in U.S. Pat. No. 6,659,102, issued Dec. 9, 2003, to Anthony L. Sico, for use in a normal pressure environment prevention of the transmission of an infectious disease from a patient to caregiving medical personnel. Masks, when used for the purpose of normal pressure environment (hereinafter, “normobaric”) infection control, have to be affixed to the patient with either a strap behind the mask or around the neck, in order to provide the requisite seal of the mask against the patient's face necessary for infection control. This method of infection control may result in aspiration hazards. Alternatively, a patient may be instructed to hold such a mask to the face, a procedure which, over time, results in the development of arm fatigue. This discomfort may result in the patient temporarily removing the mask, thereby compromising the normobaric infection control effectiveness of the mask. Patients with respiratory illnesses requiring normobaric infection control may be hypoxic, which exacerbates the problem, often requiring close monitoring. Thus, having a patient hold the mask works against effective isolation, while strapping on or wearing a tight-fitting mask may cause a claustrophobic or panic-prone patient to experience a panic attack, so as to preclude further normobaric infection control.

Oxygen hood assemblies, hereinafter “treatment hoods,” as distinguished from masks, are well known in the medical arts field and are utilized for oxygen treatment of a patient, during which, typically, the patient may be physically located in a hyperbaric chamber during the treatment. Treatment hoods are shown in U.S. Pat. No. 5,819,728, issued Oct. 13, 1988 to Scott R. Ritchie and U.S. Pat. No. 6,854,459, issued Feb. 15, 2005 to Gerald L. Cox. Typical treatment hoods are manufactured of a transparent, gas impermeable, flexible plastic material by Amron International, 1380 Aspen Way, Vista, Calif. as its 889x Series Oxygen Treatment Hoods, and by Sea-Long Medical Systems, Inc., 1983 South Park Rd, Louisville, Ky. as its Series 300 and Series 500 Hood Assemblies. Such treatment hoods typically consist of a cylindrical, collapsible, transparent hood element closed at one end, the other end normally being open and being fitted over the head of the patient undergoing the oxygen treatment by being attached to a ring placed on or above the shoulders of the patient, the ring being sealed by a sleeve which engages the patient's neck (for on the shoulders support) or a torso seal which engages the patient's chest and back (for above the shoulders support). Treatment hoods are designed for use over an extended period of time in cramped hyperbaric chambers, with patients left in isolation inside the chamber. Prior art FIG. 1A illustrates the placement of a treatment hood on a patient. Prior art FIG. 1B illustrates the parts which may be included in the treatment hood illustrated in FIG. 1A.

The use of oxygen hood assemblies, or treatment hoods, has not heretofore been considered for short-term normobaric infection control purposes in an open environment, such as use on a patient while in an ambulance, hospital room or hallway or large open area.

### SUMMARY OF THE INVENTION

I have discovered that an oxygen hood assembly type device can be used for normobaric infection control, a new application for use of this type of hood which lends itself, for example, for providing microbial filtration of a user's exhalations from the hood (positive mode isolation) or for providing microbial filtration of the user's inhalation into the hood (negative mode isolation), as appropriate, to provide the desired infection control function.

According to the apparatus aspects of the present invention, a normobaric infection control apparatus comprises a portable, inflatable oxygen safe isolation hood having an inlet port and an outlet port; and gas flow control means connected to the hood and selectively operable to maintain the hood in an inflated condition; and which, (a) when used to provide positive mode isolation of a user's exhalations, includes (i) includes connecting means for connecting the gas flow control means, including an inhalation gas conduit, between a source of gas to be inhaled by the user and the hood inlet port, and (ii) preselected filter means connected by exhaled gas conduit means between the hood outlet port and an environment into which the user's exhalations are to be expelled; and which, (b) when used to provide negative mode isolation of a user's inhalations, includes (i) connecting means for connecting the gas flow control means and preselected filter means serially, in a selectable sequence, by gas inhalation conduit means between a source of gas to be inhaled by the user and the hood inlet port, and (ii) means connecting the hood outlet port to an environment into which the user's exhalations are to be expelled.

According to the positive isolation mode method aspect of the present invention, positive mode isolation is provided for a user in conjunction with the use of an oxygen safe isolation hood having an inlet port and an outlet port by performing the following steps in a selectable order:
(a) providing for the supply of an inhalation gas from an inhalation gas supply means to the input port by connecting inhalation gas flow control means therebetween by inhalation gas supply conduit means;
(b) connecting preselected filter means between the outlet port and the environment into which exhalations of the user are to be expelled by outlet conduit means connected between the outlet port and the filter means;
(c) initiating flow of the inhalation gas between the inhalation gas supply and the hood through the inhalation gas supply conduit means;
(d) fitting the hood on the user so as to provide a positive pressure seal between the user and the surrounding environment; and
(e) adjusting the inhalation gas flow means to provide an inhalation gas flow rate sufficient to inflate the hood and maintain the user in an oxygenated condition;
   and, at a selectable time thereafter,
(f) selectively either (i) removing the hood from the user and thereafter terminating the flow of breathable gas through the inhalation gas supply conduit means, or (ii) terminating the flow of breathable gas through the inhalation gas supply conduit means and thereafter removing the hood from the user.

According to the negative isolation mode method aspect of the present invention, negative mode normobaric infection control is provided for a user in conjunction with the use of an oxygen safe isolation hood having an inlet port and an outlet port by performing the following steps in a selectable order:
(a) connecting an inhalation gas supply to the input port by connecting inhalation gas flow control means and preselected filter means therebetween by means of inhalation gas supply conduit means;
(b) connecting outlet conduit means between the outlet port and the environment into which exhalations of the user are to be expelled;
(c) initiating a flow of a gas to be inhaled between the inhalation gas supply and the hood through the inhalation gas supply conduit means;
(d) fitting the hood on the user so as to provide a positive pressure seal between the user and the surrounding environment; and
(e) adjusting the inhalation gas flow means to provide a desired inhalation gas flow rate sufficient to inflate the hood and maintain the user in an oxygenated condition;
   and, at selected time thereafter,
(f) selectively either (i) removing the hood from the user and thereafter terminating the flow of breathable gas through the inhalation gas supply conduit means, or (ii) terminating the flow of breathable gas through the inhalation gas supply conduit means and thereafter removing the hood from the user.

### BRIEF DESCRIPTION OF THE DRAWINGS

The present invention may be more readily understood by reference to the accompanying drawings, in which:

FIG. 1A is a front elevational view of a prior art hyperbaric oxygen treatment hood, as positioned on a patient for use;

FIG. 1B is an exploded view of the components of the prior art hood of FIG. 1A;

FIG. 1C is a partial plan view of a portion of the treatment hood of FIGS. 1A and 1B, illustrating its inlet and outlet ports;

FIG. 2 is a view, in perspective, of an oxygen safe isolation hood system as used for normobaric infection control according to the present invention, illustrating its configuration and use in a positive isolation mode;

FIG. 3 is a partial plan view of a portion of the isolation hood of FIG. 2, illustrating its inlet and outlet ports; and

FIG. 4 is a view, in perspective, of an oxygen safe isolation hood system as used for normobaric infection control hood according to my present invention, illustrating its configuration and use in a negative isolation mode.

### DETAILED DESCRIPTION OF THE PREFERRED EMBODIMENTS

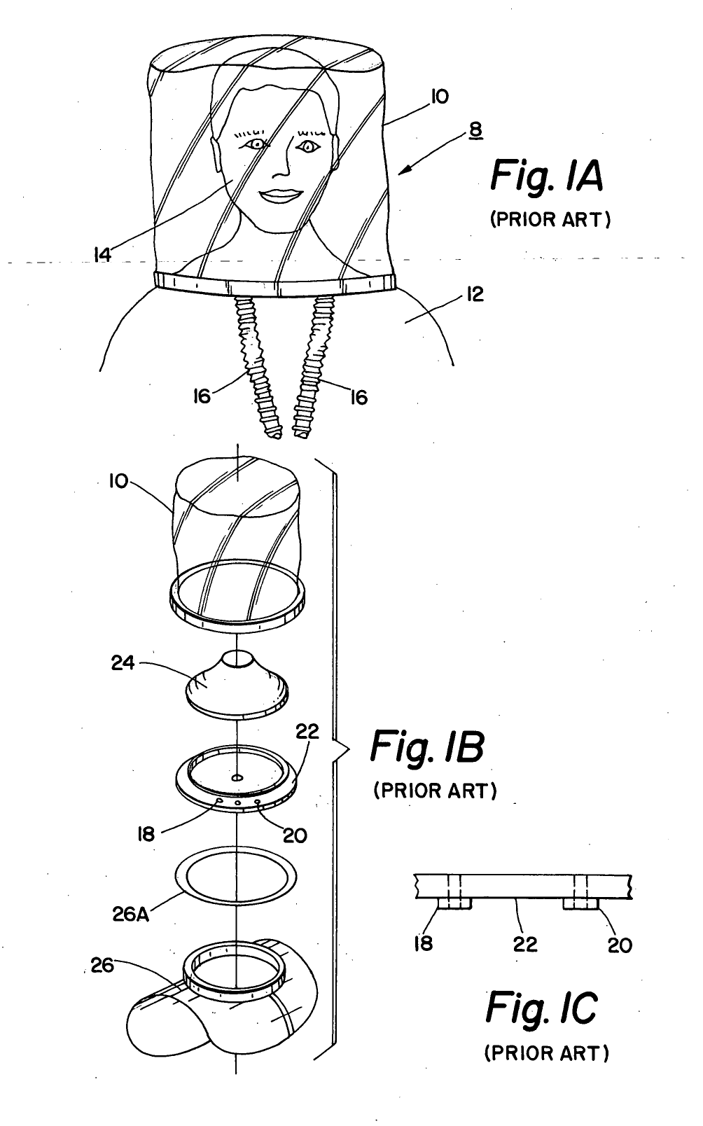

Referring first to FIG. 1, parts 1A and 1B being taken together, there is shown a typical prior art treatment hood assembly 8 of the type shown in the aforementioned U.S. Pat. No. 5,819,728. In FIG. 1A, a hood 10 is fitted on a patient or user 12 so as to enclose the user's head 14, in conventional fashion. Flexible gas inlet and outlet tubes 16A, 16B are connected to the hood 10 at ports 18, 20 of a hood ring 22 (see FIG. 1B). The ports 18, 20, best shown in FIG. 1C, include open passageways, shown in dotted lines in FIG. 1C, so as to permit free passage of gasses in and out of the hood 10. Such prior art ports are well known and are described, for example, in U.S. Pat. No. 6,854,459, issued Feb. 15, 2005 to Gerald L. Cox. The treatment hood assembly 8 normally includes either a neck seal 24 or torso seal 26 and O-ring 26A, as appropriate for the user and use for which the treatment hood 10 is employed.

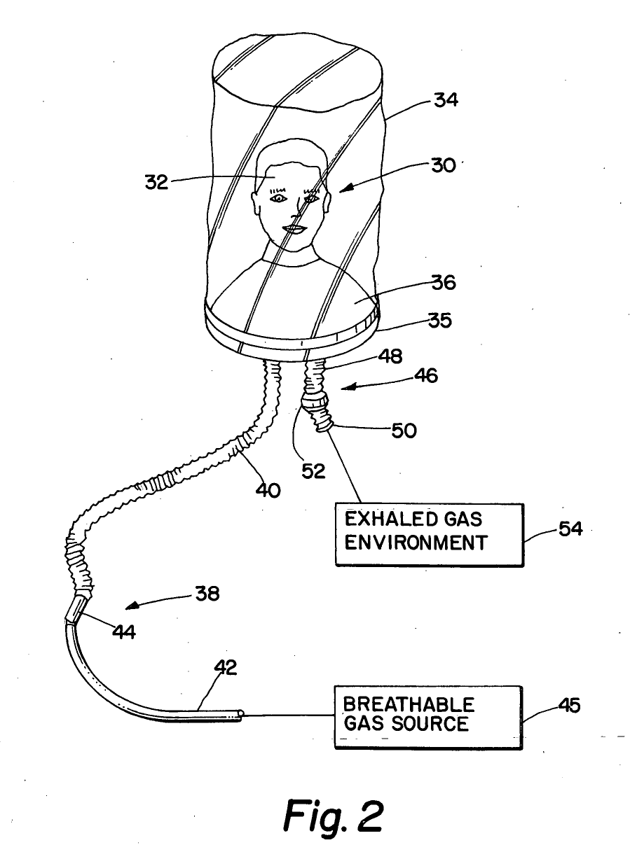

According to the present invention, an oxygen safe isolation hood system is configured either in a positive isolation mode and used to protect uninfected persons from an infected person (see FIG. 2) or in a negative isolation mode and used to protect uninfected patients from an infected person or environment (see FIG. 4).

The term “oxygen safe isolation hood,” or “isolation hood,” as used hereinafter, refers both to treatment hood assemblies such as are well known and are referred to above with respect to the prior art, and which are primarily designed for extended, and often repeated, use, and so utilize a plastic material for the hood proper which, while flexible, is more sturdy than is required for the temporary oxygenation of the user as is contemplated by the practice of the present invention and hoods designed specifically for the practice of the present invention, and so are thinner and more flexible that such prior art hoods. In the practice of the present invention, isolation hoods preferably are used which are disposable, rather than being reusable as is the present practice with treatment hoods. The preferred isolation hoods are made of thinner transparent plastic material than are conventional treatment hoods, so as to be more readily collapsible and comprise a much more compact, and less expensive, isolation hood than the prior art treatment hoods provide when used as isolation hoods in the practice of the present invention, and so constitute the presently preferred practice of the embodiments of the present invention.

Referring now to FIG. 2, the present invention, in its apparatus aspects, is illustrated with respect to providing positive mode isolation of normobaric infection control to a patient or other user 30 having a head 32. The user 30 is shown as having an isolation hood 34 with a ring 35 resting on the user's shoulders so as to enclose the head 32. The user's shoulders, along with a portion of the user's neck, are covered by a seal 36. The seal 36 may be of conventional construction, such as a neck and ring seal, or a torso seal ring seal, or a torso seal, such as are shown in FIG. 1, all of which are seal types well known in the art, and are utilized to provide a seal of the user's head 32 from the surrounding atmosphere.

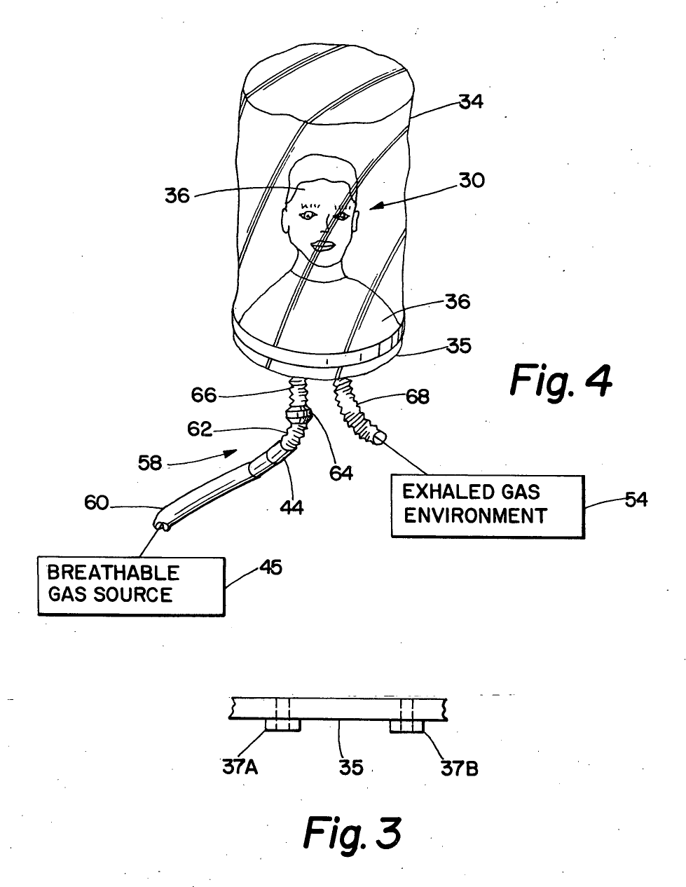

The isolation hood ring 35 has an inlet port 37A (see FIG. 3), which is of conventional construction and preferably is normally open, such as is shown with respect to the ring 22 and inlet port 18 of FIG. 1C. A fluid inlet conduit 38, preferably flexible, is connected to the inlet port 37A by conventional means. The conduit 38 has a first inlet conduit portion 40 and a second inlet conduit portion 42, between which an adjustable flow control mechanism 44 of any conventional construction is connected so as to provide fluid flow control of a gas flowing from a source of breathable gas illustrated by the block 45 to which the second inlet conduit portion 42 is connected through the flow control mechanism 44 and the first inlet conduit portion 40 to the isolation hood 34 through the inlet port. The source of breathable gas 45 preferably is an gaseous mixture containing oxygen, supplied in conventional fashion either from a self-contained supply source, such as a pressurized container which may contain a specially formulated gaseous mixture or pure oxygen, as appropriate, or from a connection to a supply source such as a hospital supply network.

The isolation hood 34 has an outlet port 37B (see FIG. 3), such as is shown with respect to the ring 22 and outlet port 20 of FIG. 1C, which is of conventional construction and preferably is normally open. In the presently preferred embodiments of the practice on the invention, as in the prior art, the ports 37A, 37B include normally open passageways, but may have check valves or other types of valving included, if desired.

A fluid outlet conduit 46, preferably flexible, is connected to the outlet port 37B by conventional means. The outlet conduit 46 has a first outlet portion 48 and a second outlet portion 50, between which a filter element 52, preselected to provide the type of filtration desired for the user's exhalations, is connected so as to provide a fluid conduit from the interior of the isolation hood 34 adjacent the user 32 to an exhalation exhaust environment, illustrated by the block 54, which for example, may be the surrounding environment in the presently preferred embodiment, or may include an appropriate container adapted to receive the exhalations, and/or a powered exhaust mechanism such as an exhaust fan, as desired. Particularly in an embodiment of the present invention in which the exhalations are being exhausted into the atmosphere or an environment at atmospheric pressure, the outlet conduit 46 has an overall length which is preselected with respect to its resistance, and the resistance of the filter 52 to the exhalations flow to provide an adequate pressure differential between the interior of the hood 34 and the surrounding atmosphere to ensure adequate evacuation of the user's exhalations from the interior of the isolation hood 34 to the environment receiving the exhalations.

Referring now to FIG. 4, in which like reference numbers refer to like elements with respect to FIGS. 2 and 3, the present invention, in another of its apparatus aspects, is illustrated as providing negative mode isolation to the user 30 about the user's head 32. The user 30 is seen to have an isolation hood 34 resting on the user's shoulders so as to enclose the head 32. In FIG. 4, the user's shoulders, along with a portion of the user's neck, are covered by a seal 36. The seal may be of conventional construction, such as a neck and ring seal, or a torso seal ring seal, or a torso seal, all of which are seal types well known in the art, and are utilized to provide a seal of the user's head from the surrounding atmosphere.

The isolation hood 34 has an inlet port 37A, to which a fluid inlet conduit 58 is connected by any conventional structure. The conduit 58 has a first inlet conduit portion 60 and a second inlet conduit portion 62, between which an adjustable flow control mechanism 44 of any conventional construction is connected so as to provide fluid flow control of a gas flowing from the source of breathable gas illustrated as the block 45 to which the first inlet conduit portion 60 is connected. The breathable gas flows through the flow control mechanism 44 and the second inlet conduit portion 62 to an inlet (not shown) of a conventional filter element 64, preselected to provide the type of filtration desired for the user's inhalations. The filter element 64 has an outlet (not shown), to which a third inlet conduit portion 66 is connected so as to provide a fluid conduit to the interior of the isolation hood 34 adjacent the user 32 through the inlet port 37A, to which the third inlet conduit portion 66 is connected.

The isolation hood 34 has an outlet port 37B, to which a fluid outlet conduit 68 is connected at one end, the other end of the conduit being illustrated as connected an environment, represented by the block 54, into which the user's exhalations are to be received. In the presently preferred embodiment, if the exhalations are to be exhausted into an environment which is at the pressure of the surrounding atmosphere, the outlet conduit 68 has an overall length which is preselected with respect to its resistance to the flow of the exhalations to provide an adequate pressure differential between the interior of the hood 34 and the surrounding atmosphere to ensure adequate evacuation of the user's exhalations from the interior of the isolation hood 34 to the environment receiving the exhalations. Alternatively, the environment represented by the block 54 may contain a powered exhaust system, such as are well known in the art.

With respect to FIG. 2, the presently preferred steps for the setup of an isolation hood system in the positive isolation mode to reduce and/or contains airborne pathogens originating from a user are as follows:

1. Removing an isolation hood, including neck and ring seal (presently preferred for achieving best results) and/or torso seal ring seal or torso seal, if supplied, from a storage container (the “Container”) containing, preferably, each of the following: the isolation hood, a flexible inhalation gas supply tube, a flexible exhaled gas outlet tube, microbial filter means, and gas flow measurement and/or control means.

2. Connecting one end of the flexible inhalation gas supply tube to an input port for the hood and attaching the other end of the supply tube either to an outlet end of the gas flow measurement device, which may be a venturi device, and the inlet end of the gas flow measurement device to a source of breathable gas through an adjustable flow meter or, alternatively, omitting the use of the venturi device and connecting the other end of the supply tube directly to the source of breathable gas through an adjustable flow meter.

3. Connecting one end of a flexible exhaust tube to the exhaust port for the hood and attaching an appropriate bacterial/viral filter (which is included in the preferred embodiment of the Container) to the other end of the exhaust tube. In the presently preferred method, in order to reduce exhalation flow resistance, the diameter of the exhaled gas tube is equal to or greater than the diameter of the gas supply tube.

4. Optionally, positioning the user in a seated or reclined position.

5. Positioning the isolation hood over the user's head so as to provide an air-tight seal with the user's body.

6. Turning on the breathable gas supply (such as oxygen, compressed air, or other breathable gas) and adjusting the supply gas flow to a flow rate appropriate for the venturi device and/or at a rate and oxygen concentration sufficient to keep the hood inflated and the user oxygenated, preferably as demonstrated clinically by pulse oxymetry or arterial blood gas analysis.

7. As the hood inflates, adjusting the flow to stabilize the hood configuration.

8. After completion of the treatment, or if removal of the hood for another reason is required, either removing the hood from the user and thereafter terminating the flow of breathable gas through the inhalation gas supply tube, or terminating the flow of breathable gas through the inhalation gas supply tube and thereafter removing the hood from the user.

An example of an appropriate venturi device is the Hudson Air Entrainment Mask, Product No. 1088, manufactured by Hudson Respiratory Care, Inc., Temecula, Calif. used from venturi masks setups. The following is an example of breathable gas flow using this venturi device and flow inspired oxygen (“FIO2”) 24% to 30%

| FIO2 | Recommended O2 Liter Flow | Total Gas Flow (to patient) |
|---|---|---|
| 24% at | 3 LPM | 79 LPM |
| 26% at | 3 LPM | 47 LPM |
| 28% at | 6 LPM | 68 LPM |
| 30% at | 6 LPM | 53 LPM |
| 35% at | 9 LPM | 50 LPM |
| 40% at | 12 LPM | 50 LPM |
| 50% at | 15 LPM | 41 LPM |

The non-linear nature of total gas flow gas flow rates will vary with different models of venturi devices.

Appropriate microbial and/or bacterial filters for use as the filter elements 52, 64 are well known in the art and are readily available from a large number of suppliers of products for use in the medical field.

With respect to FIG. 4, the presently preferred steps for the setup of an isolation hood apparatus in the negative isolation mode to reduce and/or eliminate airborne pathogens originating externally of a user are as follows:

1. Removing an isolation hood, including neck and ring seal (presently preferred for achieving best results) and/or torso seal ring seal or torso seal, if supplied, from the Container.

2. Connecting one end of the flexible inhalation gas supply tube to an input port for the hood and connecting the other end of the gas supply tube to a source of inhalation gas so as to provide a selectable gas flow rate through gas flow control means and appropriate filter means serially connected in a selectable sequence by the gas supply tube between a source of gas to be inhaled by the patient and the hood inlet port.

3. Connecting one end of a flexible exhaust tube to the exhaust port for the hood.

4. Optionally, positioning the user in a seated or reclined position.

5. Positioning the isolation hood over the user's head so as to provide an air-tight seal with the user's body.

6. Turning on the inhalation gas supply (such as oxygen, compressed air, or other breathable gas) and adjusting the supply gas flow to a flow rate appropriate for the venturi device and/or at a rate and oxygen concentration sufficient to keep the hood inflated and the user oxygenated, preferably as demonstrated clinically by pulse oxymetry or arterial blood gas analysis.

7. As the hood inflates, adjusting the flow to stabilize the hood configuration.

8. After completion of the treatment, or if removal of the hood for another reason is required, either removing the hood from the user and thereafter terminating the flow of breathable gas through the inhalation gas supply tube, or terminating the flow of breathable gas through the inhalation gas supply tube and thereafter removing the hood from the user.

In the practice of the method aspects of my invention, surgical masks may be placed on patients who are wearing the isolation hood to absorb secretions, and nebulizer treatments can be delivered directly into the hood from the input port or while a surgical mask is being worn.

An adequate, breathable, inhalation gas supply source is required for the practice of the method aspects of the present invention. The breathable gas supply may be either taken from the surrounding atmosphere, or an container of compressed air or oxygen or other supply source for an appropriate inhalation gas.

Utilizing an isolation hood according to my invention permits a user on whom it has been fitted to be seamlessly moved from an ambulance to and within a hospital, with little more than a small compressed air or oxygen cylinder, reducing cross contamination or nosocomial infections (infections passed from patient to hospitalized patient).

The isolation hood apparatus and method of my present invention can, if desired, utilize existing equipment components from different treatment modalities, with filtration and trapping of the patient's exhalation from the hood (positive isolation) or filtration of the patient's inhalation into the hood (negative isolation) to provide the desired infection control function. The physical components which are involved in the practice of my invention may be standard components, although the presently preferred embodiment utilizes hoods which are more flexible, less bulky, and less expensive than the prior art treatment hoods. There is no electrical power requirement necessarily involved in the practice of my invention in its broadest aspects. The isolation hoods and other components preferably utilized for the practice of my invention are disposable and inexpensive compared to prior art treatment hoods.

The use of my invention for infection control lends itself to use in crowded, mass casualty situations, and can be practiced by caregivers with little or no medical training and in an austere environment. Patients can hear commands, and speak. Masks or snorkel devices heretofore used tend to distort the voice. The practice of my invention is not intended to provide a definitive airway, which a caregiver could completely walk away from (i.e., endotracheal intubation), but the practice of my invention utilizing an isolation hood is inherently safer within its intended limits.

An isolation hood system according to the present invention provides for individual positive mode/negative mode isolation intended for use by medical professionals for the short duration isolation of patients either infected with respiratory pathogens (positive isolation mode) or in a physical area in when which patients may be infected with pathogens in the atmosphere or in the oxygen supply the patient is utilizing for breathing purposes (negative isolation mode). The isolation hood system practiced according to my invention contains and filters the exhalations/exhaust from patients who are breathing on their own (positive isolation mode), or filters inhalation gasses to be inhaled by patients breathing on their own in contaminated spaces in need of respiratory protection (negative isolation mode).

An isolation hood system, when utilized according to the present invention, is oxygen safe, and needs no power from an external source, other than a source of breathable gas under pressure for certain applications. The isolation hood system, for certain applications, is pre-assembled in a novel configuration, either for positive mode isolation or for negative mode isolation, according to the present invention, utilizing components approved for use with mechanical ventilators, and in systemic oxygen (normobaric and hyperbaric) treatments. The isolation hood is durable and can be used with minimal training. Hospital compressed air, oxygen, or compressed (cylinder) breathable gasses including underwater diving equipment may be adapted for use with the isolation hood.

The isolation hood is portable, and can be used for individual patients or in mass casualty situations in confined spaces when reduced patient cohorting and/or protection of patients/staff/first responders is desired. When properly supported, the isolation hood is usable in an austere environment. The isolation hood can be used to transport patients from location to location, or within a facility in the positive isolation or negative isolation modes.

Positive isolation mode and negative isolation mode configurations are operable to reduce the probability of cross-contamination by airborne respiratory pathogens. The equipment is intended for short duration use until patients can be placed in a certified isolation space, and/or deemed non-infectious. Although the presently preferred embodiments of the invention have been set forth herein in detail for illustrative purposes, it will be apparent to those skilled in the art that variations and modifications thereof, including the rearrangement of parts and method steps, lie within the scope of the present invention, which is not limited to the specific structures or step sequences of the embodiments shown or described herein, but only by the scope of the following claims.

The invention claimed is:

1. A normobaric infection control apparatus comprising:
a portable, inflatable oxygen safe isolation hood having inlet port means and outlet port means;
seal means operable to be fitted between the isolation hood and a user so that the isolation hood and seal means enclose the user's head to provide a pressure seal within the hood about the user's head;
breathable gas conduit means including gas flow control means selectively operable when connected between a breathable gas source under pressure and the isolation hood inlet port means to maintain the hood in a selectable inflated condition by means of the pressure seal and the flow of breathable gas from the gas source into the hood through the inlet port means; and
exhaled gas conduit means comprising, at least in part, the hood outlet port means; and
(a) in which, when used to provide positive mode isolation of the user's exhalations, the exhaled gas conduit means includes preselected filter means connected by the exhaled gas conduit means between the hood outlet port means and a preselected environment into which the user's exhalations are to be expelled, the exhaled gas conduit means being operable when the hood is in the selectable inflated condition to evacuate the user's exhalations from within the hood into the preselected environment; and
(b) in which, when used to provide negative mode isolation of the user's inhalations, the breathable gas conduit means includes preselected filter means connected serially with the gas flow control means, in a selectable sequence, between the source of breathable gas and the hood inlet port means, and in which the exhaled gas conduit means is operable, when the hood is in the selectable inflated condition, to evacuate the user's exhalations from within the hood into a preselected environment.

2. A method for positive mode normobaric infection control for a user in conjunction with the use of a portable, inflatable oxygen safe isolation hood having an inlet port and an outlet port by performing the following steps in a selectable order:
(a) providing for the supply of an inhalation gas from an inhalation gas supply to the input port by connecting inhalation gas flow control means therebetween by means of an inhalation gas supply conduit;
(b) connecting preselected appropriate filter means between the outlet port and the environment into which exhalations of the user are to be expelled by means of a flexible outlet conduit connected between the outlet port and to the filter means;
(c) selectively initiating flow of the inhalation gas between the inhalation gas supply and the hood through the inhalation gas supply conduit;
(d) fitting the hood on the user so as to provide a positive pressure seal between the user and the surrounding environment; and
(e) adjusting the inhalation gas flow means to provide an inhalation gas flow rate sufficient to prevent the flexible hood from collapsing and maintain the user in an oxygenated condition;
and, thereafter, in a selectable order, removing the hood from the user and terminating the flow of breathable gas through the inhalation gas supply conduit.

3. The method of claim 2, and in which the step of adjusting the inhalation gas flow means to provide an inhalation gas flow rate sufficient to prevent the flexible hood from collapsing and maintain the user in an oxygenated condition includes adjusting the flow rate to a rate to provide a pressure differential between the sealed hood and the environment into which the user's exhalations are to be received which is sufficient evacuate the user's exhalations from the hood into the environment through the preselected filter means.

4. A method for negative mode normobaric infection control for a user in conjunction with the use of a portable, inflatable oxygen safe isolation hood having an inlet port and an outlet port by performing the following steps in a selectable order:
(a) connecting an inhalation gas supply to the input port by connecting inhalation gas flow control means and preselected appropriate filter means serially therebetween by means of an inhalation gas supply conduit;
(b) connecting an outlet conduit between the outlet port and the environment into which exhalations of the user are to be expelled by extending beyond the hood;
(c) initiating flow of a gas to be inhaled between the inhalation gas supply and the hood through the inhalation gas supply conduit;
(d) fitting the hood on the user so as to provide a positive pressure seal between the user and the surrounding environment; and
(e) adjusting the inhalation gas flow means to provide an inhalation gas flow rate sufficient to prevent the flexible hood from collapsing and maintain the user in an oxygenated condition;
and, thereafter, in a selectable order, removing the hood from the user and terminating the flow of breathable gas through the inhalation gas supply conduit.

5. The method of claim 4, and in which the step of adjusting the inhalation gas flow means to provide an inhalation gas flow rate sufficient to prevent the flexible hood from collapsing and maintain the user in an oxygenated condition includes adjusting the flow rate to a rate which is sufficient to provide a pressure differential between the sealed hood and the environment into which the user's exhalations are to be received which is sufficient evacuate the user's exhalations from the hood into the environment through the outlet port.
